(19) United States
(12) Patent Application Publication
(10) Pub. No.: US 2006/0291540 A1
(43) Pub. Date: Dec. 28, 2006

(54) Apparatus for processing digital if signals capable of detecting jamming signals

(76) Inventor: Kyung Han Lee, Seoul (KR)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 10/545,891

(22) PCT Filed: Mar. 24, 2004
(86) PCT No.: PCT/KR04/00649

§ 371 Date: Jun. 7, 2006

(30) Foreign Application Priority Data
Mar. 25, 2003 (KR) 10-2003-0018546

(51) Int. Cl. H04B 1/707

(52) U.S. Cl. 375/147

(57) ABSTRACT

The present invention relates to an apparatus for processing digital signals capable of detecting jamming signals and achieving a technique using a circuit which detects whether an interference signal of a band of the received frequency exists or not. The apparatus operates from a CDMA-2000 base station device using the technique of a Digital Radio. The invention establishes the detection of jamming signals regarding a received frequency band, comprising: adding an additional digital signal processor (a received signal strength detecting part) other than a DSP which deals with a specific FA using a Multi-Carrier signal processing method of a digital wireless technique; and establishing a detecting function for jamming signals by using the additional digital signal processor as a SCAN, regarding frequency band. In addition, a RF receiver is used among the conventional jamming signal detecting apparatuses, which adds an AGC (Automatic Gain Control) to a DSP which deals with the processing a digital medium frequency signals; and jamming signal detecting function is maintained more simple and inexpensively. And since it is a frequency SCANNING method, it is possible to identify where the frequency band is occurred when a jamming signal is detected.

### TECHNICAL FIELD

The present invention relates to a digital intermediate frequency (IF) signal processing device, and more particularly, to novel systems for the digital intermediate frequency signal processing device that can effectively detect jamming signals, wherein a circuit that detects an existence of an interference signal in a received frequency band is simply realized by a digital radio technology in a CDMA-2000 base station equipment.

### BACKGROUND ART

Generally, a CDMA band station equipment should be equipped with a function which monitors the allocated frequency band that is mixed with jamming signal, such as HAM, depending on the frequency bands. In order to realize this function, an equipment with monitoring function of a received signal level within the allocated frequency band, such as a spectrum analyzer, is needed.

The above “jamming” is a military terminology that describes an act of searching a radio wave and a frequency of an enemy or an act of confusing or disturbing a communication system.

“Jamming” refers to an electronic or mechanical interference that disturbs a representation of aircrafts on a radar, radio transmission, wireless navigation, etc. “Jamming” is usually used to diminish the effect of a long-range sensor or a search equipment of the enemy. “Jamming” often times refers to “window jamming.”

This technology is first adopted in World War II, but the technology was not well used since disturbing equipments were not well developed at that time. But, as telecommunication technology has been developed, this technology has been applied to a primary military technology, for example, in the Gulf War.

When the Gulf War occurred in 1991, a U.S. intelligence satellite flying above the Persian Gulf listened to the communication of the Iraqi army, and grasped the deployment of enemy's equipments and their movement in order to secure the command of the air. Meanwhile, the U.S. paralyzed the radar of the Iraqi army by using a high-tech radio-frequency disturbance, leading to a speedy victory of the war.

When a frequency is allocated, in where jamming signals exist, an analog automatic gain control (AGC) is used at a baseband or at a IF band to a received signal, then a control voltage of this AGC is converted into digital values through an analog/digital converter. Then, a frequency band of the jamming signals is detected based on the converted values and the signal strength of the received band by a digital comparator, in order to detect the jamming frequency band.

FIG. 1 is a circuit diagram of a configuration of a jamming signal detecting device in a conventional CDMA base station device.

Referring to the diagram, reference numeral 101 denotes an antenna; reference numeral 102 denotes a Low-Noise Amplifier (LNA), which low-noise amplifies RF signals received from antenna 101; reference numeral 104 denotes a mixer, which mixes a received signals outputted from LNA 102 and a local signal outputted from local oscillator 103; reference numeral 105 denotes an amplifier, which amplifies an output signal from mixer 104 into a prescribed level; reference numeral 106 denotes Band Pass Filter (BPF), which band-pass filters an output signal from amplifier 105; and reference numeral 110 denotes an jamming signal detecting section, which detects the jamming signals from a signal outputted from BPF 106.

Jamming signal detecting section 110 is comprised of attenuator 111, which attenuates an intermediate frequency signal outputted from BPF 106 in concert with an AGC signal; coupler 112, which couples an intermediate frequency signal outputted from attenuator 111 and outputs it through 2 paths; first analog/digital converter 113, which converts an output signal from one of the 2 paths originating from coupler 112 into a digital signal; digital intermediate frequency signal processing section 114, which processes a digital intermediate frequency signal from first analog/digital converter 113; first amplifier 115, which amplifies an output signal from the other of the 2 paths originating from coupler 112 into a predetermined level; peak detector 116, which detects a peak value from an output signal from first amplifier 115; second amplifier 117, which amplifies a peak value outputted from peak detector 116 into a predetermined level, and supplies it to attenuator 111 as an AGC signal for attenuation level control and to second analog/digital converter 118, which will be described later; second analog/digital converter 118, which converts an output signal from second amplifier 117 into a corresponding digital signal; and digital comparator 119, which compares output data from second analog/digital converter 118 with reference data, and outputs a resultant data as a Received Signal Strength Indicator (RSSI).

The operation of the jamming signal detecting device in such a conventional CDMA base station device will be described in detail as follows.

First, LNA 102 low-noise amplifies a received RF signal from an antenna (a receiving antenna). Mixer 104 mixes a received signal from LNA 102 and a local signal from local oscillator 103, then extracts IF.

Amplifier 105 amplifies an output signal from mixer 104 into a predetermined level; and BPF 106 band-pass filters an output signal from amplifier 105.

Jamming signal detecting section 110, then, detects the jamming signals from an output signal from BPF 106.

The operation of a jamming signal detecting section 110 will be described in detail as follows.

In jamming signal detecting section 110, attenuator 111 attenuates an IF signals outputted from BPF 106; and coupler 112 couples an IF signal from attenuator 111 and outputs it through 2 paths.

First analog/digital converter 113 converts an output signal from one of the 2 paths originating from coupler 112 into a corresponding digital signal; and digital intermediate frequency processing section 114 processes a digital intermediate signal from first analog/digital converter 113.

First amplifier 115, then, amplifies an output signal from the other of the 2 paths originating from coupler 112 into a predetermined level; and peak detector 116 detects a peak value from output signal from first amplifier 115.

Second amplifier 117 amplifies the peak value outputted from peak detector 116 into a predetermined level, and supplies it to attenuator 111 as an AGC signal for attenuation level control and to second analog/digital converter 118 that will be described later.

Second analog/digital converter 118 converts the output signal from second amplifier 117 into a corresponding digital signal; and digital comparator 119 compares the output signal data from second analog/digital converter 118 with reference data, and outputs the resultant data as a RSSI.

The prior art has some disadvantages which are generally recognized in the industry. In the conventional jamming signal detecting device by the method generally described above, the control voltage is converted into the digital signal and the jamming signals are detected by using the digital comparator. Thus, the configuration of the circuit is complicated, and many analog elements are used, leading to a high expense to configure the overall circuit.

Furthermore, an analog AGC circuit is used. As it is well known in the industry, the precision of an analog AGC is much inferior to a digital AGC.

### BRIEF DESCRIPTION OF DRAWINGS

Understanding that these drawings depict only typical embodiments of the invention and are, therefore, not to be considered limiting of its scope, the invention will be described with additional specificity and detail through use of the accompanying drawings in which:

FIG. 1 is a circuit diagram of a configuration of a jamming signal detecting device in a conventional CDMA base station device;

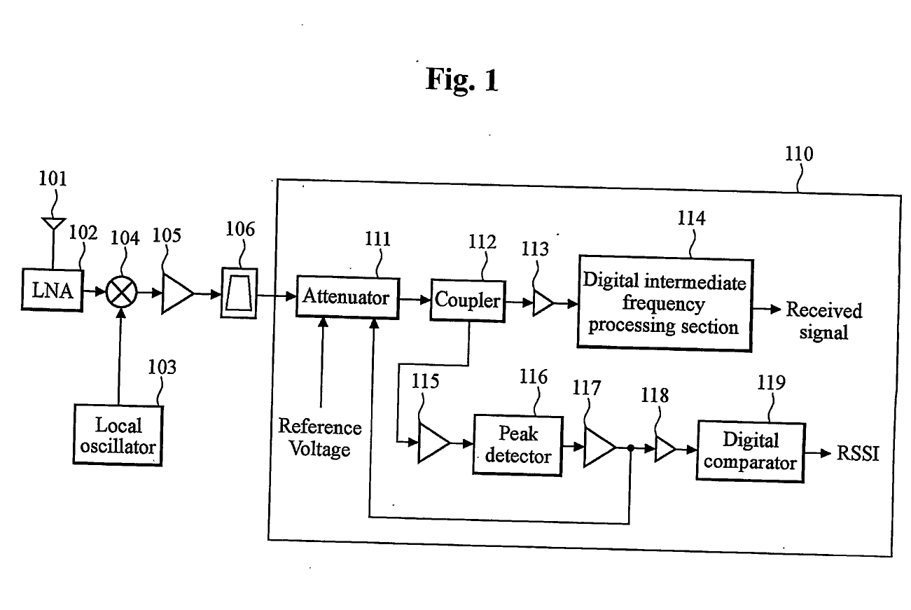

FIG. 2 is a block diagram of a first embodiment configuration of a digital intermediate frequency signal processing device that can detect the jamming signals according to the present invention;

FIG. 3 is a circuit diagram that shows an embodiment of a received signal strength detecting section;

FIG. 4 is a frequency domain that shows how a Numerically Controlled Oscillator (NCO) is changed and a frequency is scanned; and

FIG. 5 is a block diagram that shows a second embodiment of the digital intermediate frequency signal processing device that can detect the jamming signals according to the present invention.

### DISCLOSURE OF THE INVENTION

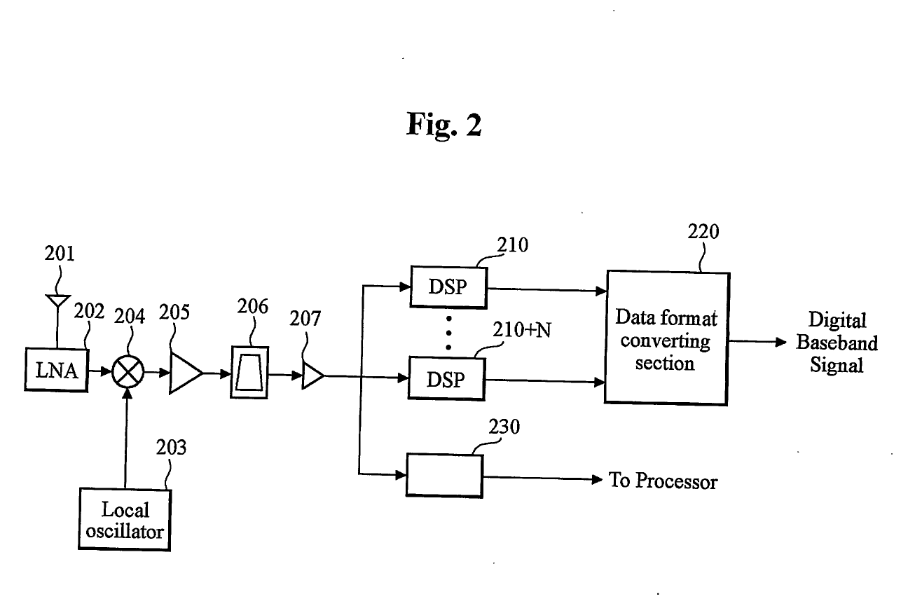

It will be readily understood that the components and steps of the present invention, as generally described and illustrated in the Figures herein and accompanying text, could be arranged and designed in a wide variety of different configurations while still utilizing the inventive concept. Thus, the following more detailed description of the preferred embodiments of the system and method of the present invention, as represented in FIGS. 2 through 5 and accompanying text, is not intended to limit the scope of the invention, as claimed, but it is merely representative of the presently preferred embodiments of the invention. The presently preferred embodiments of the invention will be best understood by reference to the drawings, wherein like parts or steps are designated by like numerals throughout.

In view of the foregoing, it is a primary object of the present invention to provide an intermediate frequency signal processing device that can effectively detect jamming signals without using a complex device at a low cost.

It is also an object of the present invention to provide a device for providing a digital intermediate frequency signal processing device that can detect jamming signals by using a digital radio technology in CDMA-2000 base station equipment.

In the present invention, an additional digital signal processor (a received signal strength detecting section) is added to a DSP that processes a particular frequency assignment (FA) by using a multi-carrier signal processing method of a digital radio technology; the added digital signal processor is used for scanning to an allocated frequency band; and a jamming signal detecting function to the received frequency band is realized.

Furthermore, an RF receiving end in a conventional jamming signal detecting device is used as it is, and a digital AGC circuit is additionally added to a board (digital signal processor: DSP) that performs a digital intermediate frequency processing. Thus, it becomes possible to achieve a jamming signal detecting function simply and at a low price. Furthermore, it becomes possible to know at what frequency band the jamming signals are detected when the jamming signals are detected.

An embodiment of the present invention to achieve the above object is a digital intermediate frequency processing device in a CDMA base station, comprising a typical RF receiving end comprising a receiving antenna, a low-noise amplifier, a local oscillator, a mixer, an amplifier, and a BPF; an analog/digital converter that converts an analog intermediate frequency signal outputted from said RF receiving end into a corresponding digital intermediate frequency signal; a plurality of digital signal processors that process the digital intermediate frequency signal outputted from said analog/digital converter; and a digital format converting section that converts an output signal from said plurality of digital signal processors into a digital baseband signal, characterized in that:

said digital intermediate frequency processing device comprises a received signal strength detecting section for detecting a received signal strength to detect jamming signals from an output signal from said analog/digital converter.

Another embodiment of the present invention to achieve the above object is a digital intermediate frequency processing device in a CDMA base station, comprising a typical RF receiving end comprising a receiving antenna, a low-noise amplifier, a local oscillator, a mixer, an amplifier, and a BPF; an analog/digital converter that converts an analog intermediate frequency signal outputted from said RF receiving end into a corresponding digital intermediate frequency signal; a plurality of digital signal processors that process the digital intermediate frequency signal outputted from said analog/digital converter; and a digital format converting section that converts an output signal from said plurality of digital signal processors into a digital baseband signal, characterized in that:

said digital intermediate frequency processing device comprises a received signal strength detecting section provided in said plurality of digital signal processors for detecting a received signal strength to detect jamming signals from an output signal from said analog/digital converter.

According to the present invention described above, it becomes possible to detect the jamming signals more splendidly and more exactly than the conventional method by adding one additional DSP.

Furthermore, since the digital intermediate frequency signal processing device that can detect the jamming signals is configured in digital form, it becomes possible to achieve better precision and reliability than the conventional analog circuit.

### BEST MODE FOR CARRYING OUT THE INVENTION

The preferred embodiments of the present invention according to the technical concept described above will be described in detail below with reference to the attached figures.

FIG. 2 is a block diagram of a first embodiment configuration of a digital intermediate frequency signal processing device that can detect the jamming signals according to the present invention.

Reference numeral 201 denotes an antenna (a receiving antenna); reference numeral 202 denotes a LNA, which low-noise amplifies a received RF signal from antenna 201; reference numeral 204 denotes a mixer, which mixes a received signal outputted from LNA 202 and a local signal outputted from local oscillator 203, and extracts IF; reference numeral 205 denotes an amplifier, which amplifies an output signal from mixer 204 into a predetermined level; and reference numeral 206 denotes a BPF, which band-pass filters an output signal from amplifier 206.

Furthermore, reference numeral 207 denotes an analog/digital converter, which converts an analog intermediate frequency signal outputted from a BPF into a corresponding digital intermediate signal; reference numeral 201-201+N denote a plurality of digital signal processors, which process a digital intermediate frequency signal from analog/digital converter 207; and reference numeral 220 denotes a data format converting section, which converts output signals from the plurality of digital signal processors 201-201+N into digital baseband signals.

Furthermore, reference numeral 230 denotes a received signal strength detecting section, which detects a received signal strength for detecting the jamming signals from an output signal from analog/digital converter 207.

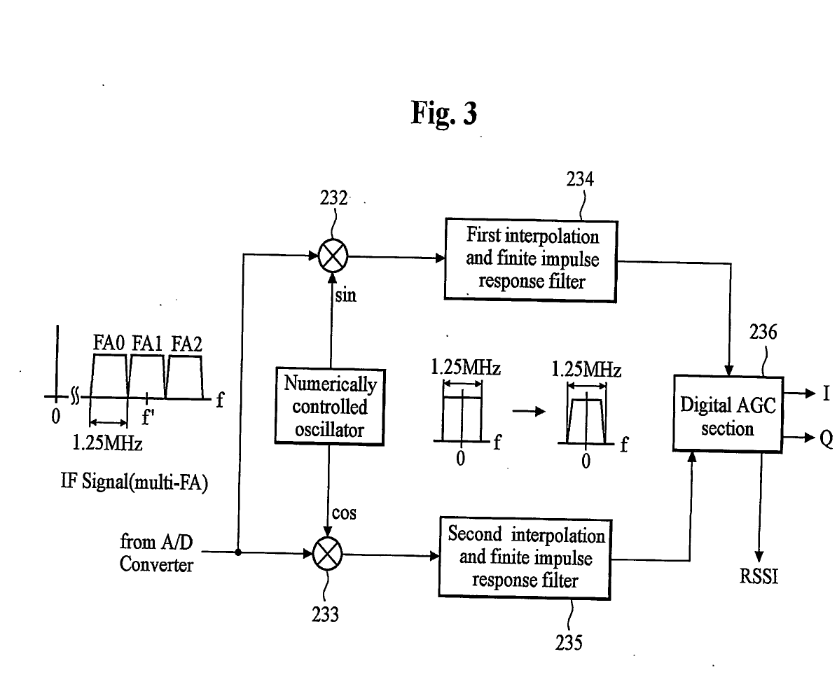

Received signal strength detecting section 230 is comprised of, as shown in FIG. 3, Numerically Controlled Oscillator (NCO) 231, which converts an oscillation frequency in concert with a control signal given in numerical form, and outputs the oscillation frequency of a sine wave and a cosine wave whose phase is different from that of the sine wave by 180°; first mixer 232, which mixes the sine wave outputted from NCO 231 and the digital intermediate frequency signal outputted from analog/digital converter 207; second mixer 233, which mixes the cosine wave outputted from NCO 231 and the digital intermediate frequency signal outputted from analog/digital converter 207; first and second interpolation and finite impulse response filters 234, 235, which improve precision and a ratio of signal and noise of the system by adding points to digital data outputted respectively from first and second mixer 232, 233, and filters and outputs them; and digital AGC section 236, which automatic-gain controls the signals outputted respectively from first and second interpolation and impulse response filters 234, 235.

The operation of the first embodiment of the digital intermediate frequency signal processing device of the present invention, which can detect the jamming signal, will be described in detail with reference to FIG. 2 to FIG. 4.

First, LNA 202 low-noise amplifies RF signal received from the antenna (the receiving antenna); and mixer 204 mixes a received signal outputted from LNA 202 and a local signal outputted from local oscillator 203, and extracts IF. Then, amplifier 205 amplifies an output signal from mixer 204; and BPF 206 band-pass filters an output signal from amplifier 205 into a set band.

Furthermore, analog/digital converter 207 converts an analog intermediate frequency signal outputted from BPF 206 into a corresponding digital intermediate frequency signal; a plurality of digital signal processors 201-201+N process a digital intermediate frequency signal outputted from analog/digital converter 207; and data format converting section 220 converts output signals from the plurality of digital signal processors 210-210+N into a digital baseband signal. This is the basic operation of a typical RF receiving end.

The first embodiment of the present invention is achieved by adding an additional digital signal processor to the conventional RF receiving end in order to detect the jamming signal.

That is, received signal strength detecting section 230 detects a received signal strength for detecting the jamming signals from the output signal from analog/digital converter 207.

The operation of received signal strength detecting section 230 will be described in further detail as follows.

As shown in FIG. 3, NCO 231 converts the oscillation frequency in concert with a control signal given in numerical form, and outputs the oscillation frequency of a sine wave and a cosine wave whose phase is different from that of the sine wave by 180°.

First mixer 232 mixes the sine wave outputted from NCO 231 and the digital intermediate frequency signal outputted from analog/digital converter 207; and first interpolation and finite impulse response filter 234 adds points to digital data outputted from first mixer 232 and increases precision and a signal to noise ratio of the system, then, filters and outputs them.

Furthermore, mixer 233 mixes the cosine wave outputted from NCO 231 and the digital intermediate frequency signal outputted from 207; and second interpolation and finite impulse response filter 235 adds points to digital data outputted respectively from second mixer 233 and increases precision and a signal to noise ratio, then filters and outputs them.

Then, digital AGC section 236 automatic-gain controls the signals outputted respectively from first and second interpolation and finite impulse response filters 234, 235 and outputs baseband signals, I, Q, while delivers the RSSI to a subsequent processor (now shown in FIG. 3) in order to determine whether the jamming signals exist.

The processor compares the RSSI of the scanned band with the RSSI of the neighboring bands and determines that the jamming signals are detected, then, gives an alarm.

That is, the first embodiment of the present invention is designed to set a bandwidth with an interpolation filter and a Finite Impulse Response (FIR) filter in order to obtain the bandwidth as required, and to change the frequency of the NCO.

For example, provided that the IF band that is used has a bandwidth from 65 MHz to 75 MHz, a detection bandwidth of the jamming signals should be decided first in order to detect the jamming signal.

If a bandwidth of 100 kHz is desired to be set, coefficients of a digital filter corresponding to a bandwidth of 100 kHz are set at the DSP, and a frequency band, the frequency of the NCO is varied from 65.05 MHz to 74.95 MHz on a unit of 100 kHz to scan the allocated frequency band.

The time required to scan the allocated band is 100 times greater than the time required to change the NCO value in the DSP and to read the RSSI value, since 10 MHz should be scanned on a unit of the band of 100 kHz. The RSSI value of the scanned band and the RSSI value of the neighboring band are compared, and it is determined that the jamming signals exist for the frequency band where a difference between the above two RSSI values is greater that than the predetermined value. Then, the jamming signal detection alarm is given.

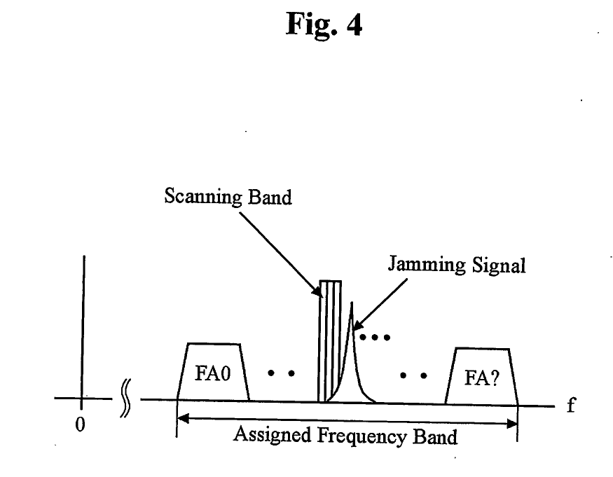

Now referring to FIG. 4, the drawing shows how the NCO is changed and scanned in the frequency domain.

The method shown in FIG. 4 has advantage in that it is possible to know whether the jamming signals are detected and to know the frequency at the time of detection of the jamming signal. However, it is possible to detect the jamming signals by the conventional method without using the DSP for scanning the frequency, when the frequency of the jamming signals does not need to be known.

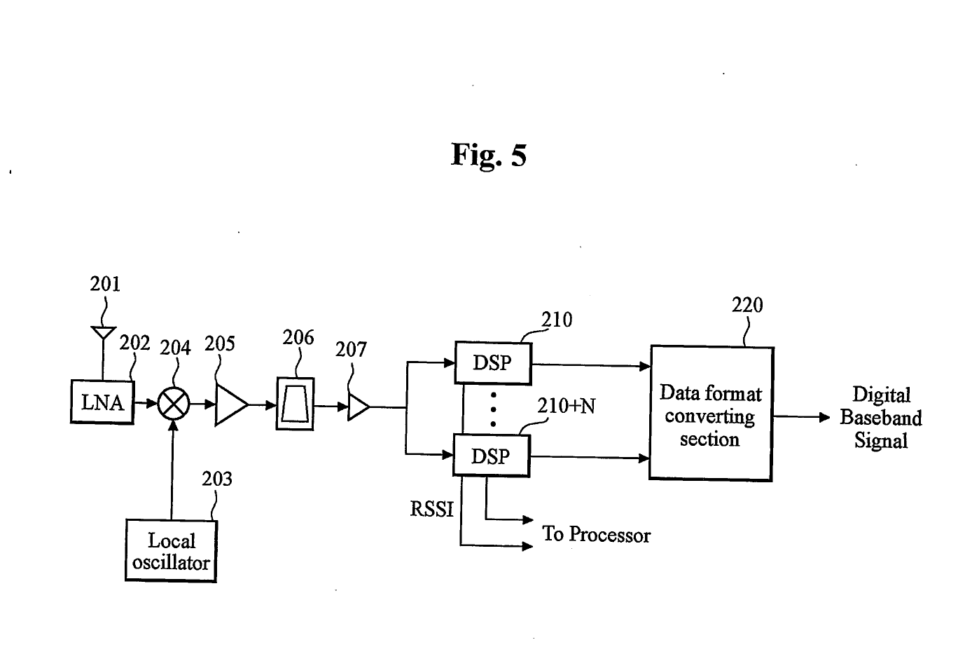

FIG. 5 is a block diagram that shows the configuration of the second embodiment of the digital intermediate frequency signal processing device that can detect the jamming signals according to the present invention. FIG. 5 shows the structure that detects the jamming signals by using the DSP.

In FIG. 5, reference numeral 201 denotes an antenna (a receiving antenna); reference numeral 202 denotes LNA that low-noise amplifies the RF signal received from antenna 201; reference numeral 204 denotes a mixer that mixes a received signal outputted from LNA 202 and a local signal outputted from local oscillator 203; reference numeral 205 denotes an amplifier that amplifies the output signal from mixer 204 into a predetermined level; and reference numeral 206 denotes a BPF that band-pass filters the output signal from amplifier 205.

Furthermore, reference numeral 207 denotes an analog/digital converter that converts the analog intermediate frequency signal outputted from BPF 206 into a corresponding digital intermediate frequency signal; reference numeral 210-210+N denote a plurality of digital signal processors that process the digital intermediate frequency signal outputted from analog/digital converter 207; and reference numeral 220 denotes a data format converting section that converts the output signals of the plurality of digital signal processors 210-210+N into a digital baseband signals.

This configuration is same to the configuration of the first embodiment shown in FIG. 2. The second embodiment comprises a received signal strength detecting section shown in FIG. 3 for detecting a received signal strength to detect the jamming signals from the output signal from analog/digital converter 207 in one of the plurality of digital signal processors (e.g. 210+N), in the configuration of the first embodiment as described above.

Likewise as in FIG. 3, since the DSP is aware of the RSSI value of the corresponding FA by the digital AGC, it is possible to monitor a level of a received signal within the allocated frequency band only with the conventional DSP.

Since this method can measure only a channel power of a received signal within the FA managed by the corresponding DSP, it is necessary to give an alarm for indicating the jamming signals only with respect to a detection of the received level that exceeds the received level of the conventional normal range.

When the reverse link structure having the structure of FIG. 3 and FIG. 5 is used with the practical digital radio technology, the normal received level is set to vary approximately from −120 dBm to −100 dBm.

In contrast, in consideration of a reasonable margin required by a particular wireless environment such as fading, it can be determined that the jamming signals have been introduced when a signal level received by the base station is −80 dBm and higher.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

1. A digital intermediate frequency processing device in a CDMA base station, comprising a typical RF receiving end comprising a receiving antenna, a low-noise amplifier, a local oscillator, a mixer, an amplifier, and a Band Pass Filter; an analog/digital converter that converts an analog intermediate frequency signal outputted from said RF receiving end into a corresponding digital intermediate frequency signal; a plurality of digital signal processors that process the digital intermediate frequency signal outputted from said analog/digital converter; and a digital format converting section that converts an output signal from said plurality of digital signal processors into a digital baseband signal, characterized in that:
said digital intermediate frequency processing device comprises a received signal strength detecting section for detecting a received signal strength to detect jamming signals from an output signal from said analog/digital converter.

2. The digital intermediate frequency processing device of claim 1, wherein said received signal strength detecting section comprises:
a Numerically Controlled Oscillator (NCO) that converts an oscillation frequency in concert with a control signal given in numerical form, and outputs, as the oscillation frequency, a sine wave and a cosine wave whose phase is different from that of the sine wave by 180°;
a first mixer for mixing the sine wave outputted from said numerical control oscillator and the digital intermediate frequency signal outputted from said analog/digital converter;
a first mixer for mixing the sine wave outputted from said numerical control oscillator and the digital intermediate frequency signal outputted from said analog/digital converter;
first and second interpolation and finite impulse response filters for adding points to digital data outputted respectively from said first and second mixers, thereby improving precision and a signal to noise ratio, and for filtering and outputting the resultant data; and
a digital automatic gain control (AGC) section for automatic-gain controlling the signals outputted respectively from said first and second interpolation and impulse response filters, and for outputting the resultant data as a Received Signal Strength Indicator (RSSI) for determining whether the jamming signals exist.

3. A digital intermediate frequency processing device in a CDMA base station, comprising a typical RF receiving end comprising a receiving antenna, a low-noise amplifier, a local oscillator, a mixer, an amplifier, and a Band Pass Filter; an analog/digital converter that converts an analog intermediate frequency signal outputted from said RF receiving end into a corresponding digital intermediate frequency signal; a plurality of digital signal processors that process the digital intermediate frequency signal outputted from said analog/digital converter; and a digital format converting section that converts an output signal from said plurality of digital signal processors into a digital baseband signal, characterized in that:
said digital intermediate frequency processing device comprises a received signal strength detecting section provided in said plurality of digital signal processors for detecting a received signal strength to detect jamming signals from an output signal from said analog/digital converter.
